(19) United States
(12) Patent Application Publication
(10) Pub. No.: US 2006/0081680 A1
(43) Pub. Date: Apr. 20, 2006

(54) Desoldering wick for lead-free solder

(76) Inventors: Kayoko Yoshimura, Osaka (JP); Takashi Uetani, Osaka (JP)

Correspondence Address: Douglas N. Larson, Esq.;Squire, Sanders & Dempsey, LLP, 14th Floor, 801 S. Figueroa Street, Los Angeles, CA, 90017-5554, US

(21) Appl. No.: 10/967,017

(22) Filed: Oct. 14, 2004

(51) Int. Cl. B23K 1/00

(52) U.S. Cl. 228/19

(57) ABSTRACT

A desoldering wick having an inner metal coating such as a 0.1 μm to 12 μm layer of tin or tin-alloy and an outer noble metal coating such as a 0.5 nm to 10 μm layer of gold, silver, platinum, palladium, or rhodium for the removal of lead-free solder; a method of manufacturing the desoldering wick; and methods of using the wick.

### BACKGROUND OF THE INVENTION

In many electronic devices, components are secured to a substrate of the electronic device using solder. The substrate may be, for example, a circuit board. Typically, solder is composed of either a lead-based alloy, such as lead-tin, or more recently, lead-free metal alloys, such as tin-copper, tin-silver, tin-silver-copper or tin-zinc. With increased environmental concerns. and regulations, lead-free solder is now broadly used.

Devices and methods for removing solder from electronic circuit boards or the like, are known. One such device is a desoldering tool with a vacuum pump and a desoldering tip. The vacuum pump may be either mechanical or electric. When using a desoldering tool with an electric vacuum pump, a problem may arise when solder remaining on the desoldering tip is left on the circuit board. The residual solder must be removed by an additional cleaning step, and this step may jeopardize the integrity of the electronic circuit board. In addition, when using a desoldering tool with a mechanical pump, the solder must first be heated with a soldering iron and then removed with the mechanical pump. This may require repeated heat applications to the same location on the circuit board from which solder is being removed in order to remove all residual traces of the solder. Exposure to repeated heat applications may peel off the pattern on a circuit board.

Another known solder removing device is a desoldering wick, which typically comprises braided copper wires coated with a metal and a flux. To remove solder, the desoldering wick is applied to the solder and a soldering iron is then applied to the desoldering wick. Heat from the soldering iron flows from the point on the wick at which heat is applied to the solder to melt the solder. When the appropriate temperature is reached, the solder is absorbed into the interstitial spaces of the braided copper wires, the heat flowing away from the solder through the copper wires. Typically, the copper wires are coated with a metal such as tin or a metal alloy. The metal coating facilitates a faster melting of the solder. Examples of desoldering wicks are shown by the following patents: U.S. Pat. Nos. 3,627,191, 4,137,369, 4,164,606, 4,416,408, 5,094,139, 5,305,941, and 5,746,367, Japanese Patent No. JP-H02-093070.U, and Japanese Application No. JP-S48-67025.U. (The entire contents of each of these documents are hereby incorporated by reference.)

The flux, on the other hand, serves two purposes, namely, to protect the metal wires from oxidation and to facilitate flow of the solder into the interstitial spaces of the metal wires. However, a large amount of flux coated on the metal wires is associated with at least two problems. One is that a typical flux, such as rosin, requires the application of organic halide activators for coating. Such activators are corrosive to electrical circuits, a typical substrate on which solder is used. Thus, any residual flux remaining on the circuit board may have to be removed after desoldering, jeopardizing the integrity of the circuit board. Additionally, exposure to flux is associated with various health problems. These problems make a desoldering wick with little or no flux a desirable improvement over the conventional desoldering wick. Finally, although a desoldering wick may be considered the simplest method of removing solder, it is often the most desirable when compared to other devices known in the art due to the limitations of the other devices, such as those devices discussed previously.

Desoldering wicks comprised of bare copper wires are known in the art. In this type of prior art desoldering wick, heat applied to the wick tends to flow away from the solder and through the copper wires due to the high thermal conductivity of copper. Thus, use of this type of desoldering wick typically requires twice as long to melt lead-free solder. Additionally, as explained herein, a desoldering wick comprised of copper wires with, for example, tin plating is known in the art. The tin, however, tends to oxidize as heat is applied to the wick resulting in lesser absorption capabilities. Flux, with the limitations as described herein, is therefore required to reduce the oxidation process.

With the advent of lead-free solder being broadly used, problems have arisen when an electronic device requires a desoldering application, for example, to change out an electrical component. One such problem is that, when compared to lead-based solders, the melting points of lead-free solders are higher. For example, the melting point of tin-copper(0.7%) is 227 degrees Celsius, tin-silver(3.5%) is 221 degrees Celsius, and tin-silver(3.5%)-copper(0.7%) is 217 degrees Celsius. In contrast, the melting point of a conventional lead-based solder comprised of, for example, tin-lead(37%), is approximately thirty to forty-five degrees lower than the other commonly used lead-free solders. The higher melting points of commonly used lead-free solders mean that higher temperatures are needed to melt the solder. Because higher temperatures must be used, the heat applied to the desoldering wick tends to flow to the wick itself rather than to the solder, making the melting of the solder more difficult. Additionally, because higher temperatures are needed to melt the lead-free solders, an electronic device substrate may be exposed to heat for a longer period of time. Longer heat exposure may destroy the pattern of the circuit board.

Another problem with lead-free solders relates to their wetness and their fluidity. Wetness measures the weight and speed with which the solder meniscus rises on the desoldering wick during solder removal. The higher the meniscus climbs, the greater the wettability. Thus, the greater the wettability, the faster the solder will absorb onto the Wick during desoldering. Fluidity, on the other hand, measures the ability of a substance to flow. Typically, lead-based solders have greater wettability and fluidity than lead-free solders. The decreased wetness and fluidity properties of lead-free solders when compared to lead-based solders means that lead-free solders are more difficult to remove from surfaces.

Yet another problem is that conventional soldering wicks may not allow unused portions and used portions of the soldering wick to be easily distinguished from one other. Tin, which has a gray color, is typically used as the metal layer in a conventional desoldering wick. The solder being removed may also typically be a gray color. Thus, once such a conventional desoldering wick is used, the user is forced to distinguish between a gray used portion of the wick and a gray unused portion of the wick. As a result, unused portions may be needlessly wasted by being removed with the used portion. Alternatively, a used portion may be inadvertently left attached to the unused portion of the wick. Thus, unaware that the used portion is still attached, a user may apply the used portion of the wick to once again remove solder, subjecting the substrate to an unnecessary amount of heat. As discussed previously, longer heat exposure may destroy the pattern of the circuit board.

### SUMMARY OF THE INVENTION

The present invention provides a lead-free desoldering wick comprising a plurality of braided metal filaments coated with at least a low melting point metal layer and a noble metal layer; a method of using the desoldering wick; and a method of manufacturing the same. Moreover, a method for distinguishing a used portion from an unused portion of the desoldering wick of the present invention is provided in at least one embodiment.

The metal filaments of the desoldering wick may be comprised of, for example, copper. The low melting point metal layer may be a single metal of tin, or may be a tin alloy of tin-copper, tin-silver-copper, tin-silver or tin-zinc. The noble metal layer may be one of silver, gold, platinum, palladium or rhodium. While the low melting point metal layer assists in accelerating the melting rate of the solder, the noble metal layer assists in preventing the oxidation of the low melting point metal layer as well as increasing the absorption capability, or fluidity, of the desoldering wick. A small amount of flux may or may not be included in the present desoldering wick to further enhance the absorption properties thereof. It is anticipated that the desoldering wick of the present invention will achieve the same results as that of lead-based desoldering wicks by the addition of a noble metal layer and the substantial reduction of flux with its harmful properties.

In the manufacturing process, the metal filaments are plated by electroplating or by chemical or electroless plating (deposition of metal coating by immersion of a metal or non metal in a suitable bath containing a chemical reducing agent). The plated filaments may be coated prior to braiding, or, alternatively, may be coated after braiding. The thickness of the plating can be controlled by time and electrical current used. The thickness of the low melting point metal layer can be approximately 0.1 to 12 μm, while that of the noble metal layer can be approximately 0.5 nm to 10 μm.

The desoldering wick of the present invention may be applied to lead-free solder on the substrate of an electrical device. A soldering iron is applied to the desoldering wick, and the lead-free solder is then absorbed into the interstitial spaces of the desoldering wick, leaving the substrate virtually free of the lead-free solder.

In one embodiment of the desoldering wick of the present invention, the second noble metal layer may be used as a visual indicator to distinguish a used portion from an unused portion of the desoldering wick. In an embodiment wherein the noble metal layer is gold, the unused portion of the wick will appear gold in color. A used portion will appear gray in color due to the absorption of solder. Thus, this embodiment allows the user to easily distinguish between a used portion and an unused portion of the desoldering wick of the present invention. The user can then remove and discard the used portion of the wick.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a plan view of a desoldering wick of the present invention.

FIG. 2 is a cross-sectional view of a metal filament of the desoldering wick of FIG. 1 before braiding, coated with a low melting point metal layer and a noble metal layer.

FIG. 3 is a cross-sectional view of a metal filament of the desoldering wick of FIG. 1 after braiding, coated with a first metal layer and a second noble metal layer.

FIG. 4 is a partial cross-sectional view of the desoldering wick of FIG. 1 coated with a low melting point metal layer and a noble metal layer.

FIG. 5 is a perspective view illustrating a method of applying the desoldering wick of FIG. 1 to a substrate to remove solder therefrom.

FIG. 6A is a side view illustrating a first step in a method of applying the desoldering wick of FIG. 1 to a substrate to remove solder therefrom.

FIG. 6B is a side view illustrating a second step in a method of applying the desoldering wick of FIG. 1 to a substrate to remove solder therefrom, wherein the solder is absorbed onto the desoldering wick of FIG. 1.

FIG. 6C is a side view illustrating a method of removing a used portion from an unused portion of the desoldering wick of FIG. 1.

FIG. 7 illustrates an alternative embodiment of the desoldering wick of FIG. 1.

FIG. 8 is a bar graph comparing the melting rates of solders using various desoldering wicks including the desoldering wick of FIG. 1.

FIG. 9 illustrates a manufacturing process of the desoldering wick of FIG. 1.

FIG. 10 illustrates an alternative manufacturing process of the desoldering wick of FIG. 1.

FIG. 11 illustrates the desoldering wick of FIG. 1 spooled on a bobbin.

FIG. 12 illustrates the desoldering wick of FIG. 1 in a holding case.

FIG. 13 is a cross-sectional view of a metal filament of the desoldering wick of FIG. 1 before braiding, coated with a low melting point metal layer, a noble metal layer and a flux layer.

FIG. 14 is a cross-sectional view of a metal filament of the desoldering wick of FIG. 1 after braiding, coated with a first metal layer, a second noble metal layer and a flux layer.

FIG. 15 is a partial cross-sectional view of the desoldering wick of FIG. 1 coated with a low melting point metal layer, a noble metal layer and a flux layer.

### DETAILED DESCRIPTION OF PREFERRED EMBODIMENTS OF THE INVENTION

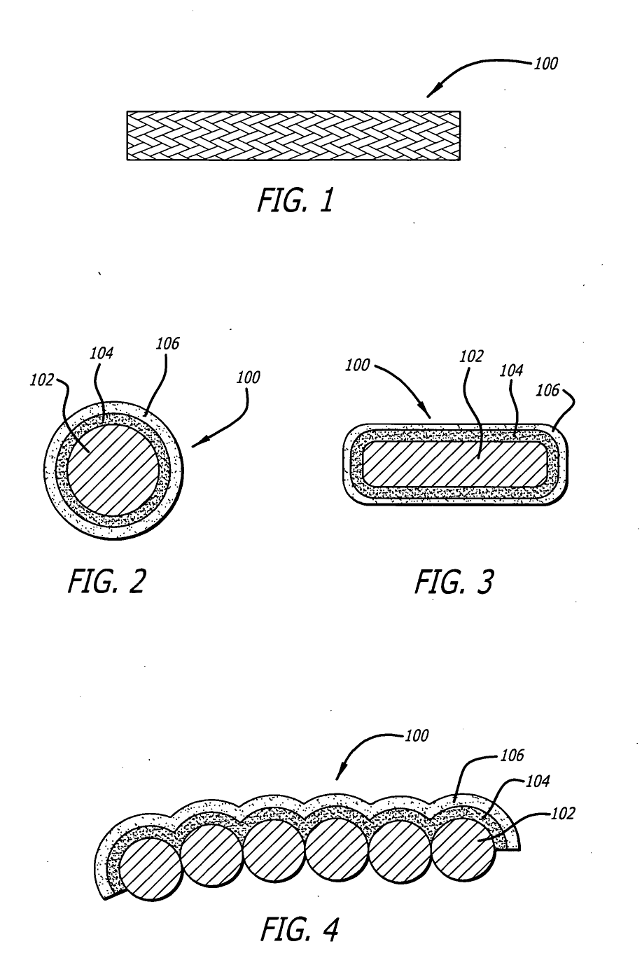

Referring to the drawings wherein like reference numerals designate like elements, FIG. 1 illustrates a preferred embodiment of a desoldering wick shown generally at 100 of the present invention. The desoldering wick 100 comprises a plurality of braided metal filaments 102 which are plated with a first metal coat 104 and a subsequent second noble metal coat 106. Between ninety and one hundred and twenty (and preferably one hundred and five) filaments are braided together to form the wick. The desoldering wick may be one to eight mm in width, typically four mm. Generally, the metal filaments 102 are comprised of copper, however, other suitable metals may be employed. Additionally, the metal filaments 102 are typically sixty μm to one hundred μm in diameter. The first metal coat 104 may be an elemental metal or a metal alloy. More specifically, the elemental metal of the first metal coat 104 may be, for example, tin, and the metal alloy of the first metal coat 104 may be a tin alloy, for example, tin-copper, tin-silver-copper, tin-silver or tin-zinc. The second noble metal coat 106 may be silver, gold, platinum, palladium or rhodium.

A cross-section of a metal filament 102 after plating is illustrated in FIG. 2. Referring thereto, the first metal coating 104 is typically 0.1 to twelve μm in thickness, and preferably 0.5 to two μm. The second noble metal coating 106 is typically 0.5 nm to ten μm in thickness, preferably gold, platinum, palladium or rhodium are 0.5 to one hundred and fifteen nm, and preferably silver is 0.5 to ten μm. Platings of the first metal coating 104 and of the second noble metal coating 106 are described more fully below.

FIG. 3 represents a cross-section of the desoldering wick 100 of FIG. 1. In this illustration, a plurality of metal filaments 102 is braided prior to the application of the first metal coating 104 and the subsequent second noble metal coating 106. FIG. 4 more clearly illustrates the coating of the desoldering wick 100 after braiding.

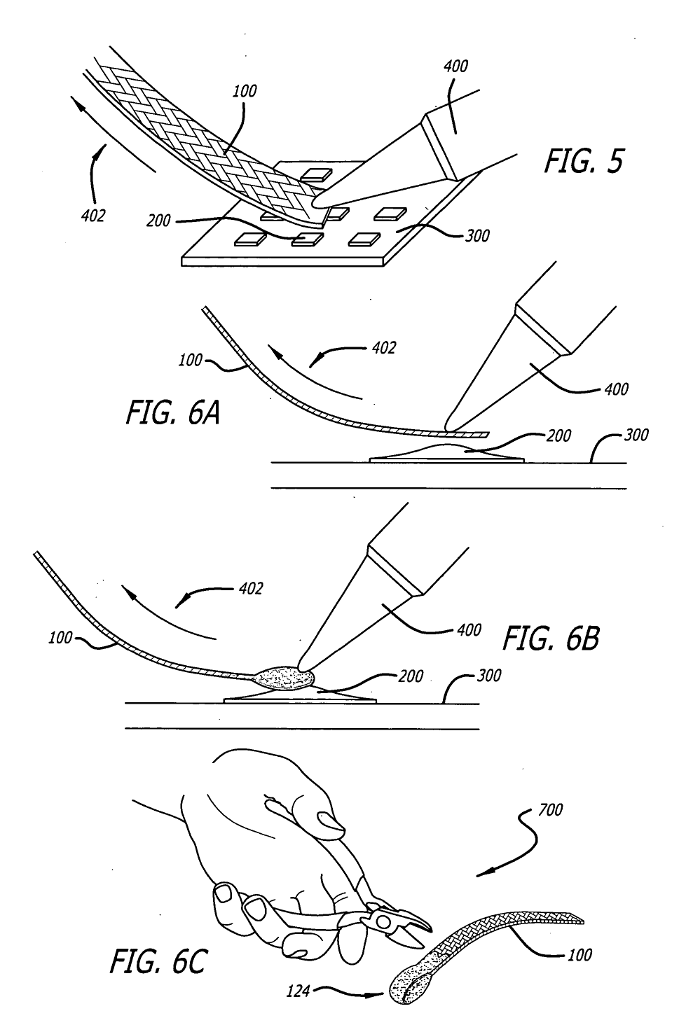

In FIG. 5, the use of the desoldering wick 100 to remove lead-free solder 200 from a substrate 300 is shown. Generally, a lead-free solder may be comprised of tin-copper, tin-silver-copper, tin-silver, or tin-zinc. As shown, the desoldering wick 100 is applied to lead-free solder 200, while a desoldering iron 400 is applied to the desoldering wick 100. Once the lead-free solder becomes molten, the lead-free solder 200 will absorb (shown by arrow 402) into the interstitial spaces of the desoldering wick 100. Depending on the composition of the lead-free solder 200, the lead-free solder will become molten at a certain temperature, such temperature typically in the range of one hundred and eighty to two hundred and twenty-seven degrees Celsius. In FIG. 6A, a side view of the use of the desoldering wick 100 to remove lead-free solder 200 from a substrate 300 is shown.

Generally, the melting temperature of the soldering material which distinguishes between a soldering work and a brazing work is 450 degrees Celsius. Lead-free solders for soldering work include tin-silver, tin silver copper, tin copper and tin zinc alloys. The melting temperatures of these materials (their liquidus temperatures) range from approximately 186 degrees Celsius to approximately 380 degrees Celsius. The first metal layer or coating 104 of the present wick 100 preferably should melt faster than the solder of the solid soldered joint so that the molten first metal on the wick will quickly transfer the heat from the soldering iron via the wick to the soldered joint (see FIGS. 5, 6A and 6B, for example). Therefore, a preferred melting temperature range of a low melting point metal (or alloy) herein is one having a melting temperature in the range of between 150 degrees Celsius to 350 degrees Celsius.

The following elementary metals are low melting point metals with melting points between 150 degrees Celsius and 350 degrees Celsius, and are listed below with their melting points in degrees Celsius: Indium (In), 156.2°; Lithium (Li), 180.5°; Tin (Sn), 232°; Polonium (Po), 254°; Bismuth (Bi), 274.1°; Thallium.(Ti), 303.5°; Cadmium (Cd), 320.8°; and Lead (Pb), 327°. The safest and least expensive of the above-listed elementary metals are indium, tin and bismuth.

Some lead-free solders contain copper, silver or antimony, which technically are not low melting point metals as their melting points are 1083°, 962° and 631° Celsius, respectively. Since these lead-free solders have the low melting point temperatures, they may be used as the low melting point metal (or alloy) of the first metal coat 104 of the desoldering wick 100. Tin is a preferred metal for the first metal or alloy coat 104 or layer, because tin is a common metal in all lead-free solders and tin residues on a joint do not materially change its composition. Additionally, tin has a melting point of 232° Celsius, which is approximately the midpoint in the above-mentioned temperature range of 150° to 350° Celsius for low melting point metals.

The first metal layer 104 of the desoldering wick 100 helps prevent heat from the desoldering iron 400 from flowing directly to the metal filaments 102 and, consequently, assists in directing the heat to the lead-free solder 200 itself. Thus, the lead-free solder 200 melts faster due to the first metal coating 104. The first metal layer 104 coating without a second oxidation-reducing coating, however, is susceptible to oxidation, rendering the removal of solder more difficult without the same.

The second noble metal layer 106 of the desoldering wick 100 assists in faster absorption of the lead-free solder 200. Because a noble metal has the property of having extremely high wettability, a typical lead-free solder 200 with low wettability will be absorbed faster by contact with the second noble metal layer 106 of the desoldering wick 100. In conventional desoldering wicks, flux in an amount up to three weight percent of a desoldering wick is used to absorb solder faster. The following Table illustrates the high weight percent of flux included in conventional desoldering wicks:

TABLE

| | Sample Wick A | | | Sample Wick B | | | Sample Wick C | | |
|---|---|---|---|---|---|---|---|---|---|
| | 1 | 2 | 3 | 1 | 2 | 3 | 1 | 2 | 3 |
| Weight before cleaning (mg) | 349.6 | 357.4 | 352.9 | 361.8 | 364.5 | 368.2 | 484.1 | 481.1 | 477.3 |
| Weight after cleaning (mg) | 346.3 | 353.3 | 348.9 | 353.7 | 357.8 | 360 | 468.5 | 465.7 | 462.3 |
| Difference(mg) | 3.3 | 4.1 | 4 | 8.1 | 6.7 | 8.2 | 15.6 | 15.4 | 15 |
| Flux contents (wt. %) | 0.944 | 1.147 | 1.133 | 2.239 | 1.838 | 2.227 | 3.222 | 3.201 | 3.143 |

| | | | |
|---|---|---|---|
| Number of copper threads | 110 | 120 | 96 |

Thus, as shown, conventional wick A includes flux in the amount of approximately >1.0 weight percent, conventional wick B includes flux in the amount of approximately >2.0 weight percent and conventional wick C includes flux in the amount of approximately >3.0 weight percent of a conventional desoldering wick, respectively. However, a large amount of flux applied to a desoldering wick has the limitations as described herein. Advantageously, the application of the second noble metal layer 106 on the desoldering wick 100 substantially reduces the need for flux to an amount approximately equal to 0.01 to 0.5 weight percent of the desoldering wick 100 while simultaneously maintaining high absorbability.

Moreover, due to inherent properties of noble metals, the second noble metal layer 106 is not as susceptible to oxidation as is, for example, tin without a coating. The second noble metal coating 106 therefore advantageously acts as an oxidation-reducing agent which further allows for easy removal of the lead-free solder.

In addition, the second noble metal layer 106 consisting of gold further may act as a visual indicator to distinguish unused portions from used portions of the desoldering wick 100, as shown in FIGS. 6A and 6B. After the desoldering wick 100 is used to remove lead-free solder from a substrate 300, the used portion 124 of the desoldering wick 100 will take on the color of the absorbed solder, typically gray. Thus, because the unused portion is gold in color, the unused portion is easily distinguished from the used portion 124. This reduces the risk of a user re-using a used portion 124 of the desoldering wick 100, which use may compromise the integrity of the substrate 300. Once the used portion 124 is distinguished from the unused portion, the used portion may be removed by a nipper or diagonal cutter 700, for example.

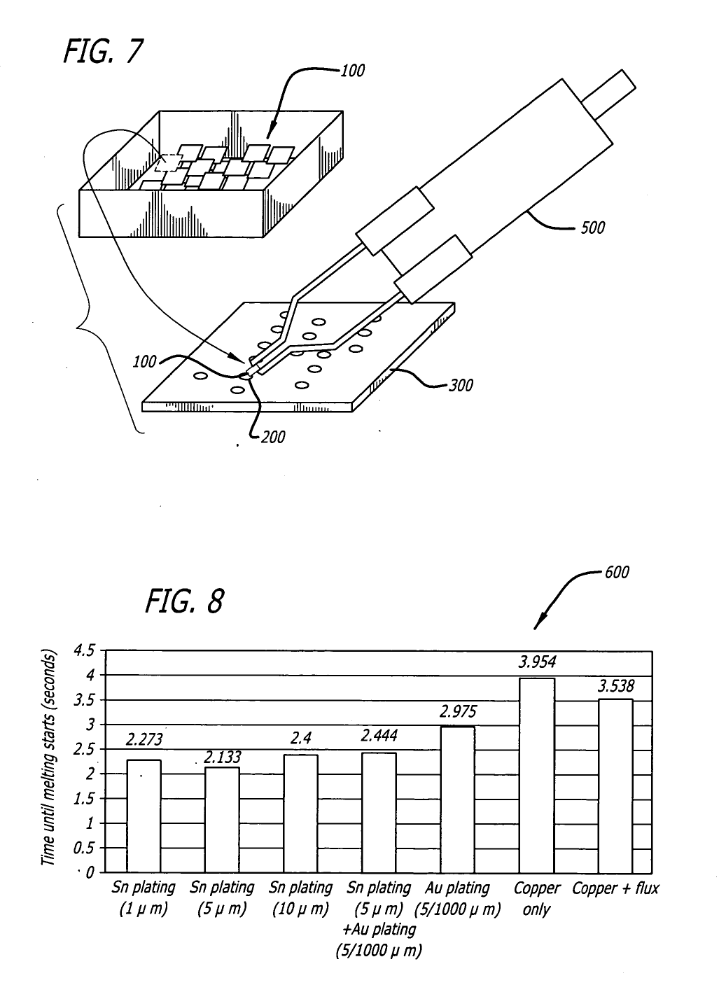

An alternative preferred embodiment of the desoldering wick 100 of the present invention is shown in FIG. 7. In this embodiment, the desoldering wick 100 is divided into small units and may be applied to a substrate 300 for removal of solder by using, for example, tweezers 500. This embodiment may be useful for removing lead-free solder 200 from very small electronic parts.

FIG. 8 is a bar graph shown generally at 600 comparing the melting rates of lead-free solder 200 using various desoldering wicks comprising at least a plurality of braided copper wires, and including a representative desoldering wick 100 of the present invention. The x-axis of the graph shows the time required for lead-free solder to start melting in seconds. The y-axis depicts various embodiments of a desoldering wick, each represented by a different bar. Shown on the y-axis, from left to right, are a desoldering wick with: tin plating at 1 μm, tin plating at 5 μm, tin plating at 10 μm, tin plating at 5 μm+gold plating at 5 nm, gold plating at 5 nm, copper with no plating and copper with no plating +flux, respectively. As shown, the melting rate of the lead-free solder 200 with application of the tin plating at 5 μm+gold plating at 5 nm, a preferred embodiment of the desoldering wick 100, is shown to be substantially the same as those coated with tin only in the amounts of 1 μm, 5 μm and 10 μm. Although a desoldering wick with tin in the amounts described may have a tendency to melt lead-free solder 200 slightly faster than the preferred embodiment, the tin of such desoldering wicks is susceptible to oxidation and thus less absorption capability as previously described. Also noteworthy is that desoldering wicks with 5 μm of gold only, no plating, and no plating+flux, respectively, all tend to melt solder at a substantially slower rate than that of the preferred embodiment. Accordingly, application of the desoldering wick 100 of the present invention advantageously results in a shorter amount of time needed to melt lead-free solder without compromising resistance to oxidation when compared to those desoldering wicks as illustrated in FIG. 8.

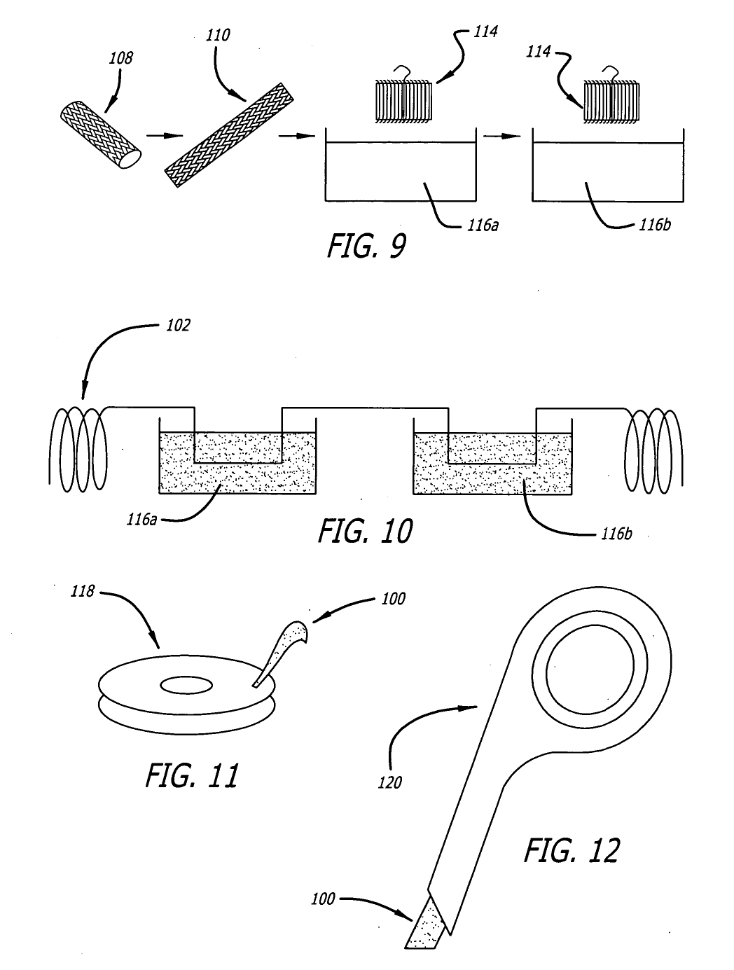

FIG. 9 represents a manufacturing process of the desoldering wick 100 of the present invention. The manufacturing process may be explained in a series of steps. First, a plurality of metal filaments 102 is braided into a barrel form 108. The barrel form 108 is then shaped to a flat form 110, or a braided wick, with a roller. Next, the braided wick is degreased, rinsed and activated. The degreasing solvent may be, for example, a combination of sodium hydroxide, a sodium silicate oxide and an activator, while the rinsing liquid may be water, and the activation solvent may be a 10% solution of hydrochloric acid. After activation, the braided wick is placed on a hangar-like device 114 in preparation for plating.

At least two plating baths 116a and 116b are provided for the plating process: one for application of the first metal coating 104 and another for the application of the second noble metal coating 106. The braided wick is plated with a first metal coating 104 in plating bath 116a, and then a second noble metal coating 106 in plating bath 116b. In an alternative embodiment, the twice-coated braided wick may be coated with a flux, such as rosin, by methods known in the art. The method of plating may be, for example, electroplating, chemical or electroless plating, all of which are well known methods of plating.

The thickness of the coating can be controlled by time and electrical current. For example, the first metal coating 104 may be applied by the immersion of the braided wick in a plating bath 116a for a period of between twelve seconds and twenty minutes, preferably approximately ten seconds, and subjected to between 0.2 to 2.0 amperes/dm² of electrical current. Similarly, the second noble metal coating 106 may be applied by the immersion of the coated braided wick in a plating bath 116b for a period of between ten seconds and twenty minutes, preferably approximately thirty-five seconds, and subjected to between 0.2 to 2.0 amperes/dm² of electrical current. The resulting twice-coated braided wick is then dried and ready for use (or a subsequent process step).

FIG. 10 shows an alternative manufacturing process of the desoldering wick 100. In this process, the metal filaments 102 undergo electroplating, chemical or electroless plating before braiding. Generally, the process is the same as that described in FIG. 9 except that the variables to control thickness,. such as time and electrical current, may need to be adjusted accordingly. For example, the first metal coating 104 may be applied by the immersion of the metal filament 102 in a plating bath 116a for a period of between twelve seconds and twenty minutes, preferably approximately ten seconds, and subjected to between 0.2 to 2.0 amperes/dm² of electrical current. Similarly, the second noble metal coating 106 may be applied by the immersion of the coated metal filament 102 in a plating bath 116b for a period of between ten seconds and twenty minutes, preferably approximately thirty-five seconds, and subjected to between 0.2 to 2.0 amperes/dm² amperes of electrical current. In an alternative embodiment, the twice-coated metal filament 102 may be coated with a flux, such as rosin, by methods known in the art. The resultant coated metal filaments 102 may then be braided into a barrel form 108 and subsequently shaped into a flat form by a roller. The resultant desoldering wick 100 may then be spooled on a bobbin 118 (see FIG. 11) and stored in a case 120 (see FIG. 12).

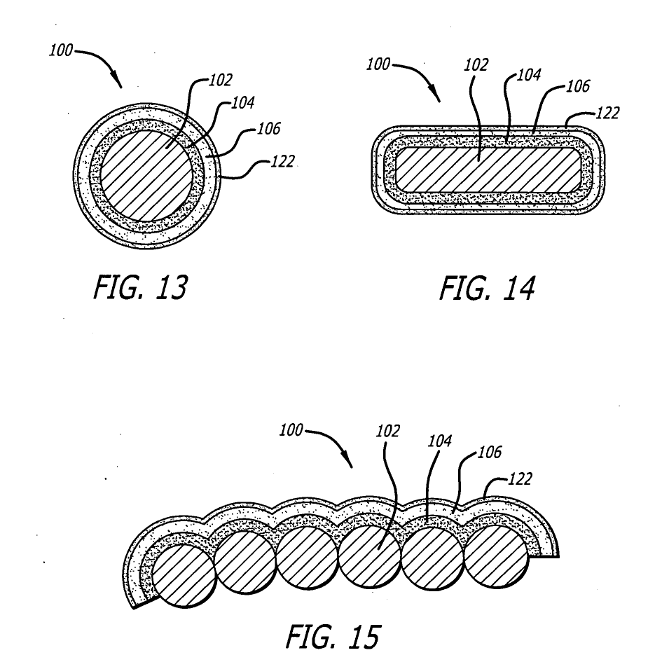

In FIG. 13, a cross-section of a metal filament 102 of an alternative embodiment of the desoldering wick 100 is shown. In this embodiment, the metal filament 102 is coated with a first metal coating 104, a second noble metal coating 106 and a third flux coating 122. The first metal coating 104 is typically 0.1 to 10 μm in thickness, preferably 0.5 to 2 μm. The second noble metal coating 106 is typically 0.5 to one hundred and fifteen nm thick, preferably gold, platinum, palladium, or rhodium is five to twenty nm, and preferably silver is 0.5 to ten μm. The third flux coating 122 is typically 0.01 to 0.5 weight percent of the desoldering wick 100.

FIG. 14 is a cross-section of an alternative embodiment of the desoldering wick 100 of FIG. 1. In this illustration, a plurality of metal filaments 102 is braided prior to the application of the first metal coating 104, the second noble metal coating 106 and the third flux coating 122. FIG. 15 more clearly illustrates the coating of the alternative embodiment of the desoldering wick 100 after braiding.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

What is claimed is:

1. A solder removal wick, comprising:
a plurality of metallic filaments, the metallic filaments being braided and shaped to form a generally flat wick;
a first metallic layer coated on the surface of the flat wick; and
a second noble metal layer coated on the first metallic layer.

2. The solder removal wick of claim 1, wherein the first metallic layer is a low melting point metal or alloy which has a melting temperature between 150 and 250 degrees Celsius.

3. The solder removal wick of claim 2, wherein the low melting point metal or alloy is a tin or a tin alloy.

4. The solder removal wick of claim 1, wherein the first metallic layer is between 0.1 and 12 μm in thickness.

5. The solder removal wick of claim 1, wherein the second noble metal layer is gold, platinum, palladium, or rhodium.

6. The solder removal wick of claim 5, wherein the second noble metal layer is between 0.5 and 115 nm in thickness.

7. The solder removal wick of claim 1, wherein the second noble metal layer is silver.

8. The solder removal wick of claim 7, wherein the second noble metal layer is between 0.5 to 10 μm in thickness.

9. The solder removal wick of claim 1, wherein the metallic filaments are copper.

10. The solder removal wick of claim 1, wherein the metallic filaments are each approximately between 60 and 100 μm in diameter.

11. The solder removal wick of claim 1, wherein the flat wick contains approximately 0.01 to 0.5 weight percent of flux.

12. The solder removal wick of claim 11, wherein the flux is rosin.

13. The solder removal. wick of claim 1, wherein the plurality of metallic filaments includes between 90 and 120 filaments.

14. The solder removal wick of claim 1, wherein the first metallic layer is tin or an alloy thereof and the second noble metal layer is gold.

15. A solder removal wick, comprising:
an elongated pad of braided wires;
a first coating of metal on the pad; and
a second coating of noble metal on the first coating.

16. The solder removal wick of claim 15, wherein the braided wires are copper wires.

17. The solder removal wick of claim 15, wherein the braided wires are approximately 60 and 100 μm in thickness.

18. The solder removal wick of claim 15, wherein the metal of the first coating is tin or a tin alloy.

19. The solder removal wick of claim 15, wherein the first coating is between 0.1 and 12 μm in thickness.

20. The solder removal wick of claim 15, wherein the noble metal of the second coating is one of gold, platinum, palladium, or rhodium.

21. The solder removal wick of claim 20, wherein the second coating is between 0.5 and 115 nm in thickness.

22. The solder removal wick of claim 15, wherein the noble metal of the second coating is silver.

23. The solder removal wick of claim 22, wherein the second coating is between 0.5 to 10 μm in thickness.

24. The solder removal wick of claim 15, wherein the solder removal wick contains approximately 0.01 to 0.5 weight percent of flux.

25. The solder removal wick of claim 24, wherein the flux is rosin.

26. The solder removal wick of claim 15, wherein the pad has a thickness between 0.2 mm and 0.8 mm and a width between 3 mm and 10 mm.

27. A solder removal wick, comprising:
a plurality of metallic filaments, the metallic filaments braided and shaped to form a generally flat wick;
a tin layer coated on the surface of the flat wick wherein the thickness of the tin layer is between 0.1 and 12 μm; and
a gold layer coated on the tin layer wherein the thickness of the gold layer is between 0.5 and 115 nm.

28. The solder removal wick of claim 27, wherein the metallic filaments are copper.

29. The solder removal wick of claim 27, wherein the metallic filaments are each approximately 60 and 100 μm in thickness.

30. The solder removal wick of claim 27, wherein the solder removal wick contains approximately 0.01 to 0.5 weight percent of flux.

31. The solder removal wick of claim 30, wherein the flux is rosin.

32. The solder removal wick of claim 27, wherein the plurality of metallic filaments includes between 90 and 120 filaments.

33. A solder removal wick, comprising:
a plurality of metallic filaments, the metallic filaments being braided and shaped to form an approximately flat wick;
a first tin layer coated on the surface of the flat wick wherein the thickness of the first tin layer is between 0.1 and 12 μm;
a second gold layer coated on the first tin layer wherein the thickness of the second gold layer is between 0.5 and 115 nm; and
a third layer of flux coated on the second gold layer wherein the flux is in the range of between 0.01 and 0.5 weight percent of the coated flat wick.

34. The solder removal wick of claim 33, wherein the metallic filaments are copper.

35. The solder removal wick of claim 33, wherein the metallic filaments are each approximately 60 and 100 μm in thickness.

36. The solder removal wick of claim 33, wherein the flux is rosin.

37. The solder removal wick of claim 33, wherein the plurality of metallic filaments includes between 90 and 120 filaments.

38. A solder removal wick, comprising:
a plurality of metallic filaments;
a tin layer coated on the surfaces of the plurality of metallic filaments wherein the thickness of the tin layer is between 0.1 and 12 μm; and
a gold layer coated on the tin layer wherein the thickness of the gold layer is between 0.5 and 115 nm.

39. The solder removal wick of claim 38, wherein the metallic filaments are copper.

40. The solder removal wick of claim 38, wherein the metallic filaments are each approximately 60 and 100 μm in thickness.

41. The solder removal wick of claim 38, wherein the flat wick contains approximately 0.01 to 0.5 weight percent of flux.

42. The solder removal wick of claim 41, wherein the flux is rosin.

43. The solder removal wick of claim 38, wherein the plurality of metallic filaments includes between 90 and 120 filaments.

44. The solder removal wick of claim 38, wherein the plurality of metallic filaments is braided and shaped to form a generally flat wick.

45. A method of manufacturing a lead-free desoldering wick, comprising:
braiding a plurality of copper wires into a braid;
shaping the braid into a flat braided wick;
cleaning the flat braided wick to form a cleaned flat braided wick;
plating the cleaned flat braided wick with tin or a tin alloy to form a flat tin-coated or tin alloy-coated wick in a first plating step; and
plating the flat tin-coated or tin alloy-coated wick with one of silver, gold, platinum, palladium or rhodium in a second plating step.

46. The method of claim 45, wherein the flat braided wick is approximately 60 to 100 μm in thickness.

47. The method of claim 45, wherein the shaping is with a roller.

48. The method of claim 45, wherein the first and second plating steps are electroless plating.

49. The method of claim 45, wherein the first and second plating steps are controlled by time and electrical current.

50. The method of claim 45, wherein the time for the first plating step is approximately 12 seconds to 20 minutes.

51. The method of claim 45, wherein the electric current for the first plating step is approximately 0.2 to 2.0 amperes/dm².

52. The method of claim 45, wherein the time for the second plating step is approximately 10 seconds to 20 minutes.

53. The method of claim 45, wherein the electric current for the second plating step is approximately 0.2 to 2.0 amperes/dm².

54. The method of claim 45, further comprising coating the flat tin-coated or tin alloy-coated wick with a flux coating.

55. The method of claim 45, wherein the flux coating is approximately 0.01 to 0.5 weight percent of the coated wick.

56. The method of claim 45, wherein the cleaning includes degreasing, rinsing and activating the flat wick using one or more solvents.

57. The method of claim 45, wherein the cleaning is with a solvent.

58. A method of manufacturing a lead-free desoldering wick, comprising:
plating a plurality of metal filaments with one of tin or a tin alloy to form first coated filaments in a first plating step;
plating the first coated filaments with one of silver, gold, platinum, palladium or rhodium to form second coated filaments in a second plating step;
braiding the second coated filaments into a braid wick; and
shaping the braid wick into a flat wick.

59. The method of claim 58, wherein the flat wick is approximately 60 to 100 μm in thickness.

60. The method of claim 58, wherein the shaping is with a roller.

61. The method of claim 58, wherein the first and second plating steps are electroless plating steps.

62. The method of claim 58, wherein the time for the first plating step is approximately 12 seconds to 20 minutes.

63. The method of claim 58, wherein the electric current for the first plating step is approximately 0.2 to 2.0 amperes/dm².

64. The method of claim 58, wherein the time for the second plating step is approximately 10 seconds to 20 minutes.

65. The method of claim 58, wherein the electric current for the second plating step is approximately 0.2 to 2.0 amperes/dm².

66. The method of claim 58, further comprising coating the second coated filaments with flux.

67. The method of claim 66, wherein the amount of flux is approximately 0.01 to 0.5 weight percent of the coated wick.

68. A method of using a solder removal wick, comprising:
providing a solder removal wick coated with a first inner layer of tin or a tin alloy, and a second outer layer of gold, the solder removal wick having a gold color, which is used to indicate when a portion of the solder removal wick is unused;
applying the solder removal wick to solder on a substrate;
applying a soldering iron to the solder removal wick;
allowing the solder to be absorbed on the solder removal wick wherein the absorbed solder colors the solder removal wick a substantially gray color;
removing the solder removal wick from the substrate; and
cutting off the used portion of the solder removal wick indicated by the gray color.

69. The method of claim 68, further comprising after the cutting, disposing of the cut used portion of the solder removal wick.
